(19) United States
(12) Patent Application Publication
(10) Pub. No.: US 2012/0244806 A1
(43) Pub. Date: Sep. 27, 2012

(54) MEMORY DEVICE AND METHOD OF CONTROLLING THE SAME

(75) Inventor: Masahiro Sekiya, Inagi-shi (JP)

(73) Assignee: KABUSHIKI KAISHA TOSHIBA, Tokyo (JP)

(21) Appl. No.: 13/233,253

(22) Filed: Sep. 15, 2011

(30) Foreign Application Priority Data
Mar. 23, 2011 (JP) 2011-064934

(51) Int. Cl. H04B 7/00

(52) U.S. Cl. 455/41.2

(57) ABSTRACT

According to one embodiment, a memory device includes a first interface, a wireless communication unit, and first and second memories. The wireless communication unit is capable of wireless communication. The first memory is nonvolatile and capable of storing data. The second memory is capable of temporarily holding data received by the wireless communication unit. The wireless communication unit sets, by transmitting a first frame, a period during which data is not transmitted to the wireless communication unit when remaining capacity of the second memory has become smaller than first capacity.

### CROSS-REFERENCE TO RELATED APPLICATIONS

This application is based upon and claims the benefit of priority from prior Japanese Patent Application No. 2011-064934, filed Mar. 23, 2011, the entire contents of which are incorporated herein by reference.

### FIELD

Embodiments described herein relate generally to a memory device and a method of controlling the memory device.

### BACKGROUND

In recent years, most electronic devices, including digital televisions, digital video recorders, digital cameras, mobile phones, and notebook computers, are provided with a memory card slot. An electronic device can exchange data with another electronic device via a memory card in the card slot.

In addition, a memory card provided with a wireless communication function has appeared on the market. Use of such a memory card enables a wireless communication function to be added to an electronic device via a USB (Universal Serial Bus) interface or a memory card interface.

### BRIEF DESCRIPTION OF THE DRAWINGS

FIG. 1 is a block diagram of a wireless communication system according to a first embodiment;

FIG. 2 is a block diagram of a memory card according to the first embodiment;

FIG. 3 and FIG. 4 schematically show a MAC frame and a BlockAck frame according to the first embodiment, respectively;

FIG. 5 and FIG. 6 are flowcharts to explain operations of a memory card and a mobile phone according to the first embodiment, respectively;

FIG. 7 is a timing chart to explain a frame sequence according to the first embodiment;

FIG. 8 and FIG. 9 are flowcharts to explain operations of a memory card and a mobile phone according to a second embodiment;

FIG. 10 is a timing chart to explain a frame sequence according to the second embodiment;

FIG. 11 and FIG. 12 are flowcharts to explain operations of a memory card and a mobile phone according to a third embodiment;

FIG. 13 is a timing chart to explain a frame sequence according to the third embodiment;

FIG. 14 schematically shows a BlockAck frame according to a fourth embodiment;

FIG. 15 and FIG. 16 are flowcharts to explain operations of a memory card and a mobile phone according to the fourth embodiment;

FIG. 17 is a timing chart to explain a frame sequence according to the fourth embodiment;

FIG. 18 is a flowchart to explain an operation of a memory card according to a fifth embodiment;

FIG. 19 and FIG. 20 are block diagrams of a memory card according to a sixth and a seventh embodiment, respectively;

FIG. 21 is a flowchart to explain an operation of the memory card according to the seventh embodiment;

FIG. 22 is a timing chart to explain a frame sequence according to the seventh embodiment;

FIG. 23 is a block diagram of a memory card according to an eighth embodiment; and

FIG. 24 is a flowchart to explain an operation of the memory card according to the eighth embodiment.

### DETAILED DESCRIPTION

In general, according to one embodiment, a memory device includes: a first interface; a wireless communication unit; and first and second memories. The wireless communication unit is capable of wireless communication. The first memory is nonvolatile and capable of storing data. The second memory is capable of temporarily holding data received by the wireless communication unit. The wireless communication unit sets, by transmitting a first frame, a period during which data is not transmitted to the wireless communication unit when remaining capacity of the second memory has become smaller than first capacity.

### First Embodiment

A memory device according to a first embodiment and a method of controlling the memory device will be explained below.

### 1. Configuration

### 1.1 Wireless Communication System

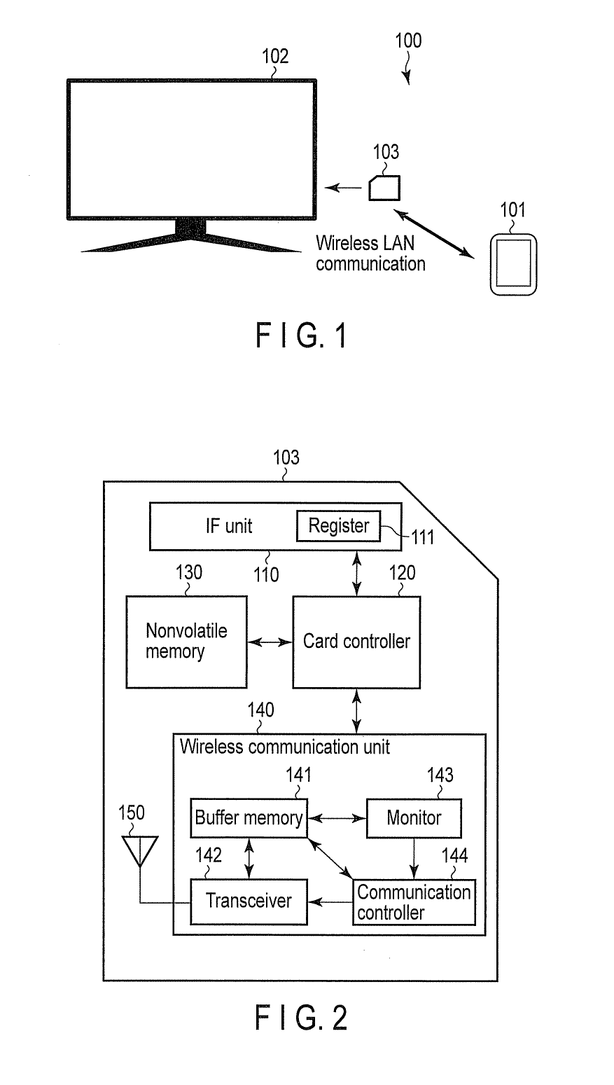

First, a wireless communication system according to the first embodiment will be explained with reference to FIG. 1. FIG. 1 is a block diagram of the wireless communication system.

As shown in FIG. 1, the wireless communication system 100 includes a mobile phone 101, a television 102, and a memory card 103. The mobile phone 101 has a wireless LAN (hereinafter, referred to as wLAN) communication function. The television 102 has a card slot in which the memory card 103 is to be inserted. The memory card 103 operates using a power supply from the television 102. The memory card 103 has not only a data storage function but also a wLAN communication function. That is, the insertion of the memory card 103 causes a wLAN communication function to be added to the television 102.

With the above configuration, the mobile phone 101 and memory card 103 perform wLAN communication.

1.2 Configuration of Memory Card 103

Next, a configuration of the memory card 103 will be explained with reference to FIG. 2. FIG. 2 is a block diagram of the memory card 103.

As shown in FIG. 2, the memory card 103 includes an interface unit (IF unit) 110, a card controller 120, a nonvolatile memory 130, a wireless communication unit 140, and an antenna 150.

The nonvolatile memory 130 stores data in a nonvolatile manner. That is, data stored in the nonvolatile memory is not erased even if the power supply to the nonvolatile memory 130 is stopped. The nonvolatile memory 130 is a semiconductor memory, such as a NAND flash memory. In the NAND flash memory, data is written and read in sets of a plurality of memory cells. A set of memory cells is called a page. That is, data is written into and read from the NAND flash memory in pages. The capacity of a page is, for example, 2K bytes (=16K bits).

The IF unit 110 controls connection with an electronic device (television 102 in this embodiment) in which the memory card 103 is inserted. With wired connection, the IF unit 110 transmits data to the television 102 or receives data from the television 102. When the memory card 103 is an SD™ card, the IF unit 110 is an SD interface. The IF unit 110 includes a register 111. The register 111 can hold status information on, for example, the memory card 103. The television 102 can grasp the present status of the memory card 103 by reading information from the register 111.

The wireless communication unit 140 is configured so as to comply with the IEEE 802.11 (including also IEEE 802.11a, IEEE 802.11b, IEEE 802.11g, and IEEE 802.11n). The wireless communication unit 140 receives a wireless signal from a wLAN device embedded in the mobile phone 101 via the antenna 150 or transmits a wireless signal to the wLAN device embedded in the mobile phone 101. As shown in FIG. 2, the wireless communication unit 140 roughly includes a buffer memory 141, a transceiver 142, a monitor 143, and a communication controller 144.

The buffer memory 141 temporarily holds reception data from the mobile phone 101 or transmission data supplied from the card controller 120. Generally, the time required for the buffer memory 141 to write and read data is shorter than that of the nonvolatile memory 130. In the memory card 103, the capacity of the nonvolatile memory 130 is set as high as possible, taking into account its physical size, cost, and the like. In contrast, the buffer memory 141 is often configured to have as low a capacity as possible. Therefore, when data is written into the nonvolatile memory 130, it is conceivable that the buffer memory 141 is already full.

The transceiver 142 transmits and receives data. Specifically, when transmitting data, the transceiver 142 modulates or D/A converts transmission data in the buffer memory 141 and transmits the resulting data at the antenna 150. When receiving data, the transceiver 142 A/D converts or demodulates data received by the antenna 150 and stores the resulting data in the buffer memory 141. In addition, under the control of the communication controller 144, the transceiver 142 transmits various management frames and control frames or outputs received management frames and control frames to the communication controller 144.

The monitor 143 monitors the availability (free space) of the buffer memory 141 and informs the communication controller 144 of the availability.

The communication controller 144 controls the operation of the entire wireless communication unit 140. Specifically, when the communication controller 144 receives a data transmission instruction from the card controller 120, it causes the transceiver 142 to transmit data. In addition, the communication controller 144 constructs various management frames and control frames, and instructs the transceiver 142 to transmit them.

The card controller 120 controls the operation of the entire memory card 103. For example, when the card controller 120 receives a data write instruction from the television 102 via the IF unit 110, it writes received data into the nonvolatile memory 130. In addition, when receiving a read instruction from the television 102, the card controller 120 reads data from the nonvolatile memory 130 and outputs the data to the television 102 via the IF unit 110.

Furthermore, when the card controller 120 receives a data transmit instruction from the television 102 via the IF unit 110, it not only transfers transmission data to the wireless communication unit 140 but also issues a data transmit instruction for the mobile phone 101 to the wireless communication unit 140. In addition, when the wireless communication unit 140 receives data from the mobile phone 101, the card controller 120 reads received data from the buffer memory 141 and writes the data into the nonvolatile memory 130 and/or outputs the data to the television 102 via the IF unit 110.

1.3 Configuration of MAC Frame

Next, a configuration of a MAC frame transmitted/received at the wireless communication unit 140 will be explained. The format of a general MAC frame includes a MAC header, a frame body, and a Frame Check Sequence (FCS).

Necessary information for a receiving process in a MAC layer is set in the MAC header. Information (such as data from a higher layer) according to the type of frame is set in the frame body. A Cyclic Redundancy Code (CRC) used to determine whether the MAC header and frame body have been received properly is set in the FCS.

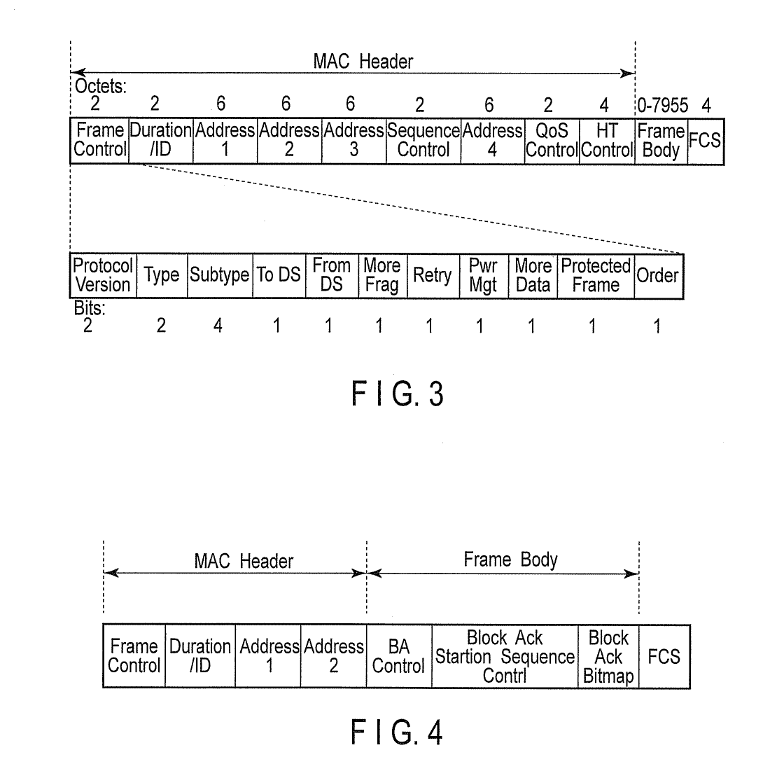

An example of the configuration of a MAC frame in a wLAN system complying with the IEEE 802.11 standard is shown in FIG. 3. As shown in FIG. 3, the MAC header includes a Frame Control field, a Duration/ID field, Address fields (Address 1 to Address 4 in FIG. 3), a Sequence Control field, a QoS Control field, and an HT Control field.

A value corresponding to the type of frame is set in the Frame Control field. A transmission standby period (NAV: Network Allocation Vector) is set in the Duration/ID field. A direct destination or final destination of the MAC frame and/or the MAC address of a transmitter is set in the Address field. A sequence number of data to be transmitted or a fragment number when data is fragmented is set in the Sequence Control field. The QoS Control field and HT Control field will be described later.

The Frame Control field includes a Protocol Version field, a Type field, a Subtype field, a “To Ds” field, a “From DS” field, a more fragment field, a Retry field, a PwrMgt field, a “More Data” field, a Protected Frame field, and an order field.

The Protocol Version field indicates the version of a MAC protocol.

The Type field indicates the type of the MAC frame. That is, from a bit string set in the Type field, it can be determined which of a control frame, a management frame, and data frame the present frame belongs to.

In addition, a bit string in the Subtype field indicates the type of a MAC frame in each frame type.

Information as to whether the receiving station is either a wireless base station or a wireless terminal is set in the “To DS” field. Information as to whether the transmitting station is either a wireless base station or a wireless terminal is set in the “From DS” field. For example, if it is a frame transmitted from a wireless base station to a wireless terminal, “0” is set in the “To DS” field and “1” is set in the “From DS” field. If “1” is set in both “To DS” field and “From DS” field, this means that it is a frame exchanged between wLAN base stations. In this case, an Address 4 field is added to the MAC header. In the other settings, an Address 4 field is not added.

The More Fragment field holds information as to whether there is a subsequent fragment frame when data has been fragmented.

The Retry field indicates that the MAC frame is transmitted again.

The power management (PwrMgt) field indicates that the memory card goes into a power save mode after a frame with “1” set in the PwrMgt field has been transmitted.

The “More Data” field informs a wireless terminal (a mobile phone 101 in this example) to go into a power save mode that buffered data is still present.

In the Protected Frame field, information as to whether the frame has been protected is set.

Information that indicates that the order of frames must not be changed when frames are relayed, or information as to whether an HT Control field is added, is set in the order field.

For example, when it has been determined from the Type field of the properly received frame that the frame is a data frame, a bit string set in the Subtype field can be checked to see if the data is QoS data or non-QoS data.

In the QoS data frame, a QoS Control field is added to the MAC header (conversely, in non-QoS data, a QoS Control field is not added to the MAC header). Therefore, if the determination result has shown that it is QoS data, the QoS Control field is checked. The QoS Control field includes TID fields (16 types of fields 0 to 15) in which identifiers corresponding to data traffics and an Ack policy field in which a transmission acknowledge method is set. Checking the TID field enables the traffic type of data to be recognized. Checking the Ack policy field makes it possible to determine whether the QoS data has been transmitted by Normal Ack policy, Block Ack policy, or No Ack policy. If a bit string meaning Normal Ack policy is set in the Ack policy field, this means that the transmission of an immediate response frame is requested when a QoS data frame has been received. On the other hand, when a non-QoS data (Subtype field indicating “Data”) frame has been received, the transmission of an immediate response frame is always requested. The order field in non-QoS data indicates information meaning that the order of frames must not be changed.

The HT Control field can be used in communication between wireless communication devices complying with the IEEE 802.11n standard. The HT Control field is added only when a MAC frame transmitted with a physical layer frame format determined only in the IEEE 802.11n standard is QoS data or a management frame and “1” is set in the order field (whether a received physical layer frame is a physical frame format determined only in the IEEE 802.11n standard can be determined on the basis of transfer frame information from a physical layer processing part (not shown) of the transceiver 142). The HT Control field includes information for supporting a Link Adaptation function and others determined in the IEEE 802.11n standard.

In FIG. 3, a number written above each field in the MAC header represents the length (size) of each field in octets. One octet is equal to 8 bits. A number written above each field in the Frame Control field also represents the length (size) of each field in bits. As shown in FIG. 3, the maximum length of the MAC header is, for example, 36 octets (36 bytes). However, the length of the MAC header differs according to the type of frame.

FIG. 4 is a schematic view of a transmission-acknowledge frame, showing a BlockAck frame as an example. When data is transmitted, a plurality of data frames for transmission may be aggregated. Such a frame is called an aggregated MAC Protocol Data Unit (A-MPDU). It is a BlockAck frame that acknowledges transmission of an A-MPDU including a plurality of data frames with a single frame. The transmission-acknowledge frame is a kind of control frame.

As shown in FIG. 4, in the BlockAck frame, a MAC header includes a Frame Control field, a Duration/ID field, and an Address field. In addition, a frame body includes a BA Control field, a BlockAck Bitmap field, and a BlockAck Starting Sequence Control field.

The BA Control field includes a TID field indicating an identifier corresponding to traffic included in the QoS Control field of the data frame. In the BlockAck bitmap field, transmission-acknowledge information indicating that the data frame has been received properly is set. More specifically, information that shows which of a plurality of data frames aggregated have been received properly and improperly is set in the BlockAck Bitmap field. The BlockAck Starting Sequence Control field includes the sequence number of a data frame. This is the start sequence number of transmission-acknowledge information shown in the Block Ack Bitmap field. The other fields are as explained in FIG. 3.

### 2. Operation

Hereinafter, operations of the mobile phone 101 and memory card 103 will be explained taking as an example a case where the mobile phone 101 acts as a data transmitter, the memory card 103 acts as a data receiver, and the mobile phone 101 transmits data to the mobile phone 101.

### 2.1 Operation of Memory Card 103

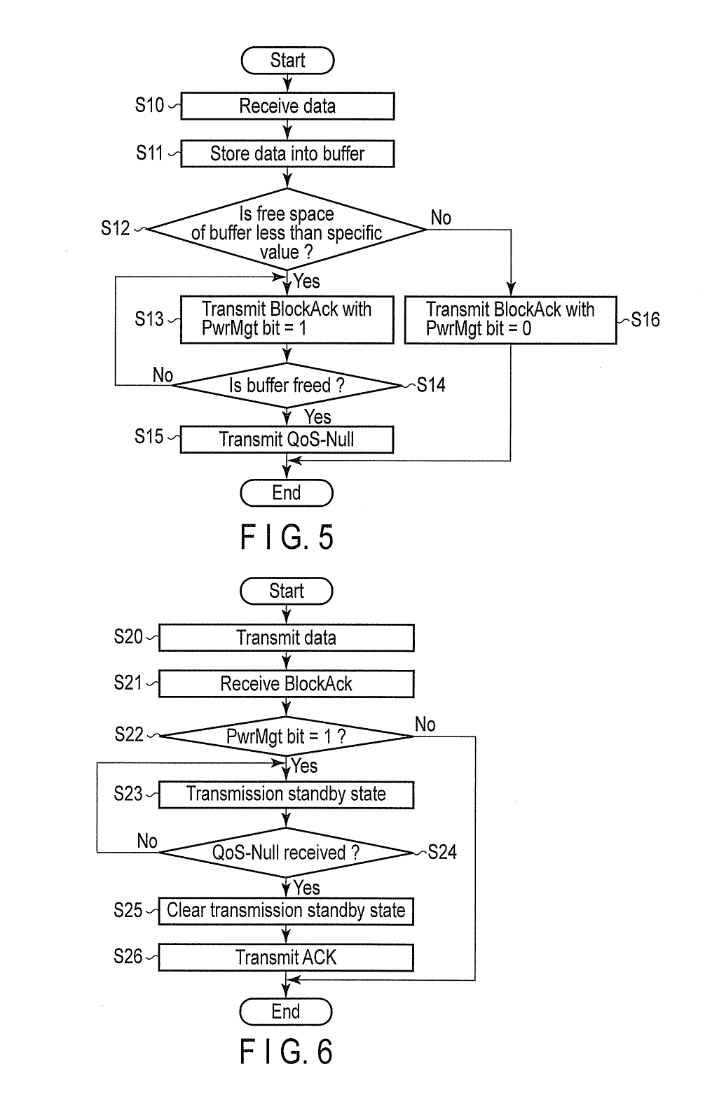

First, an operation of the memory card 103 will be explained with reference to FIG. 5. FIG. 5 is a flowchart to explain the flow of operation of the memory card 103.

As shown in FIG. 5, when receiving data at the transceiver 142 (step S10), the memory card 103 stores the data in the buffer memory 141 (step S11). When the data has been stored in the buffer memory 141 and the size of data has reached a write unit (e.g., 2K bytes) in the nonvolatile memory 130, the card controller 120 reads data from the buffer memory 141 and writes the data into the nonvolatile memory 130.

The monitor 143 monitors whether the free space of the buffer memory 141 has decreased below a specific value and supplies the monitoring result to the communication controller 144. The specific value may be, for example, the size of one data frame or a fixed value, such as 512 bytes. That is, the specific value may be selected suitably.

When the free space of the buffer memory 141 has decreased below the specific value (YES in step S12), the communication controller 144 that has received the information sets a bit in the PwrMgt at “1” and transmits a BlockAck frame (step S13). Specifically, the communication controller 144 sets a bit in the PwrMgt field at “1” to construct a BlockAck frame. Then, the communication controller 144 not only supplies the BlockAck frame to the transceiver 142 but also instructs the transceiver 142 to transmit the BlockAck to the mobile phone 101. According to the instruction, the transceiver 142 transmits the BlockAck frame to the mobile phone 101 via the antenna 150. As a result, the memory card 103 inhibits the mobile phone 101 from transmitting data to the memory card 103.

After having transmitted the BlockAck frame, the communication controller 144 checks the free space of the buffer memory 141 via the monitor 143. When the free space of the buffer memory 141 has reached a specific capacity or more (YES in step S14), the communication controller 144 transmits a QoS-Null frame to the mobile phone 101 (step S15). Although not shown, the QoS-Null frame also has a PwrMgt field. In step S15, the communication controller 144 sets “0” in the PwrMgt field of the QoS-Null frame. As a result, the memory card 103 clears the inhibition of the mobile phone 101 from transmitting data to the memory card 103.

In step S12, if the free space of the buffer memory 141 is equal to or larger than the specific value (NO in step S12), the communication controller 144 sets a bit in the PwrMgt field at “0” of a BlockAck frame and transmits the same (step S16).

In step S10, if the communication controller 144 has determined that the data has been received properly, the card controller 120, on the basis of the determination, stores information indicating a busy state, i.e., wireless communication, in the register 111 of the IF unit 110. Referring to the information in the register 111, the television 102 can recognize that the memory card 103 is in operation (in wireless communication). Information that indicates a busy state, i.e., wireless communication, may be not only stored in the register 111 but also notified to the television 102 by the IF unit 110.

### 2.2 Operation of Mobile Phone 101

Next, an operation of the mobile phone 101 will be explained with reference to FIG. 6. FIG. 6 is a flowchart to explain the flow of operation of the mobile phone 101.

As shown in FIG. 6, the mobile phone 101 transmits data to the memory card 103 (step S20) and then receives a BlockAck frame about the data (step S21). Then, the mobile phone 101 checks the value of the PwrMgt field in the received BlockAck frame. If the bit in the PwrMgt field is “1” (YES in step S22), the mobile phone 101 transitions to the transmission standby state (step S23). The mobile phone 101 remains in the transmission standby state until a QoS-Null frame with the bit in the PwrMgt field being “0” has been received (NO in step S24).

When having received a QoS-Null frame (YES in step S24), the mobile phone 101 clears the transmission standby state (step S25) and transmits a response frame (ACK frame) to the QoS-Null frame to the memory card 103 (step S26). After that, the mobile phone 101 starts to transmit data again.

### 2.3 Concrete Example of Operation

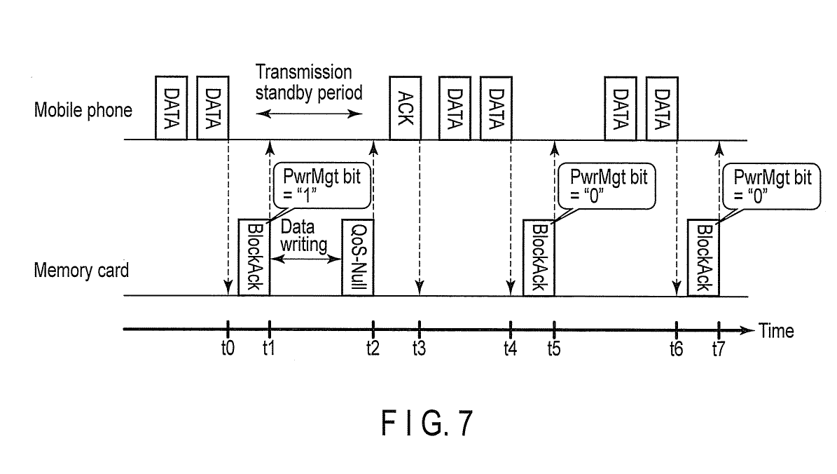

A concrete example of the operations of mobile phone 101 and memory card 103 will be explained with reference to FIG. 7. FIG. 7 shows a frame sequence when the wLAN device embedded in the mobile phone 101 transmits two data frames in three bursts and the wireless communication unit 140 embedded in the memory card 103 receives the data frames.

To increase the communication efficiency, the interval between data frames consecutively transmitted is set to as short a value as possible in the range determined by a wireless communication standard to which the wireless function corresponds. For example, in the IEEE 802.11 standard, SIFS (16 μsec) or RIFS (2 μsec) is selected. In addition, the frame interval between a data frame and a BlockAck frame is set to the smallest one determined by the wireless communication standard. For example, in the IEEE 802.11 standard, SIFS (16 μsec) is selected.

Each of the data frames shown in FIG. 7 represents one frame. An aggregation frame determined in the IEEE 802.11n standard may be used by aggregating the data frames.

As shown in FIG. 7, suppose, when two data frames are received at time t0, the free space of the buffer memory 141 of the memory card 103 has decreased below the specific value. Then, the memory card 103 sets “1” in the PwrMgt field of a BlockAck frame and transmits the BlockAck frame to the mobile phone 101 at time t1. This inhibits the mobile phone 101 from transmitting data to the memory card 103.

Thereafter, data in the buffer memory 141 is transferred to the nonvolatile memory 130. As a result, when the free space of the buffer memory 141 has become equal to or larger than the specific value, the memory card 103 transmits a QoS-Null frame to the mobile phone 101 at time t2. Then, the mobile phone 101 transmits an ACK frame for the QoS-Null frame to the memory card 103 at time t3.

This clears the inhibition of data transmission to the memory card 103. Then, the mobile phone 101 transmits two data frames to the memory card 103 again.

Suppose in the memory card 103 that received two data frames at time t4, the free space of the buffer memory 141 is equal to or larger than the specific value. Then, the memory card 103 transmits a BlockAck frame with “0” set in the PwrMgt field to the mobile phone 101 at time T5. Since “0” is set in the PwrMgt field, the mobile phone 101 continues transmitting data frames to the memory card 103 without changing to the transmission standby state.

### 3. Effects of the First Embodiment

As described above, the configuration of the first embodiment enables efficient access. This effect will be explained below.

In a standard for a memory card using a nonvolatile memory as in the SD memory card interface standard, a protocol takes into account the time required to write data into the nonvolatile memory.

On the other hand, in a wireless communication standard, such as a wireless LAN, a protocol does not take into account the time required to write data transferred via a wireless channel into the nonvolatile memory.

Here, consider a case where a nonvolatile memory, a memory controller, and a wireless LAN function are embedded in the SD memory card. For example, when the speed at which the memory controller writes data into the nonvolatile memory is faster than the speed at which data is communicated by wireless LAN, data received via wireless LAN will transferred to the nonvolatile memory without problems. However, if the speed at which data is communicated by wireless LAN is faster, data received via wireless LAN cannot be written into the nonvolatile memory and might be discarded.

A method of avoiding this is to use a higher-level protocol that performs flow control, such as TCP/IP. However, this increases the operating power of a processor that performs a TCP/IP process, which is not preferable.

In this respect, with the configuration of the first embodiment, the mobile phone monitors the free space of the buffer memory 141 that temporarily holds data received by wireless communication. When the free space of the buffer memory 141 is running short, a response frame (BlockAck frame) transmitted by the memory card 103 informs the mobile phone 101, a transmitter of data frames, of transmission waiting, temporarily stopping the transmission of data frames from the mobile phone 101. Thereafter, when the free space of the buffer memory 141 increases, the memory card transmits a frame (Qos-Null frame) that notifies an increase in the free space to the mobile phone 101. Exchanging this frame and corresponding response frame causes a temporary stop of data frame transmission to be cleared.

On the other hand, when there is sufficient free space in the buffer memory 141, a response frame transmitted by the memory card 103 informs the mobile phone 101 of the continuation of transmission. This enables the mobile phone 101 to continue transmitting data frames to the memory card 103.

Consequently, the memory card 103 can control data frame transmission from the mobile phone 101 suitably, depending on the status of use of the buffer memory 141 of the memory card. Therefore, a situation where the memory card 103 with no space in the buffer memory 141 receives data frame and discard the data frame is avoided. Therefore, efficient data communication can be performed.

Furthermore, with the configuration of the first embodiment, when wireless data communication is started, a host device (television 102 in the first embodiment) that supplies electric power is informed that wireless communication is in progress. As a result, power supplying is prevented from being stopped during wireless communication. This suppresses the occurrence of the necessity of retransmitting data uselessly and contributes to efficient data communication.

### Second Embodiment

Next, a memory device and a method of controlling the memory device according to a second embodiment will be explained. The memory device according to the second embodiment is such that the transmission standby period of a mobile phone 101 and information that the information on the standby period is shown in a Duration field are stored in the Duration field of a BlockAck frame transmitted by a memory card 103 in the first embodiment. Hereinafter, only what differs from the first embodiment will be explained.

### 1. Configuration

The configuration of the memory card 103 is as shown in FIG. 2 explained in the first embodiment. What differs from the first embodiment is explained in the following points.
When the free space of a buffer memory 141 is less than a specific value, a communication controller 144 calculates the length of a transmission standby period of the mobile phone 101 according to the free space.
The calculated transmission standby period and information that it has been stored are set in the Duration field of a BlockAck frame that inhibits the mobile phone 101 from transmitting data frames.

### 2. Operation

Next, operations of the memory card 103 and mobile phone 101 will be explained below, taking as an example a case where the mobile phone 101 acts as a transmitter and the memory card 103 acts as a receiver as in the first embodiment.

### 2.1 Operation of Memory Card 103

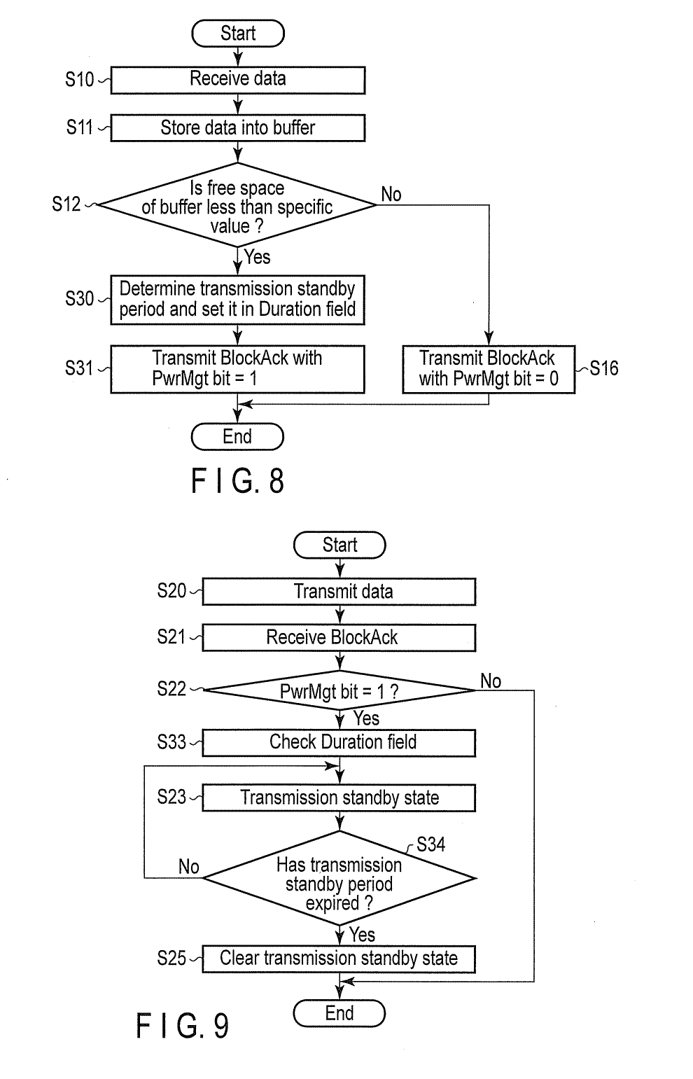

First, an operation of the memory card 103 will be explained with reference to FIG. 8. FIG. 8 is a flowchart to explain the flow of operation of the memory card 103.

As shown in FIG. 8, in the flowchart of FIG. 5 in the first embodiment, when the free space of the buffer memory 141 is less than the specific value (YES in step S12), the communication controller 144 determines the length of a transmission standby period to be set in the mobile phone 101 and sets this in the Duration field of the BlockAck frame (step S30). For example, if a unit of field is 32 μec, when “10 (decimal number)” is set in the Duration field, the length of a transmission standby period is 320 μsec.

Then, the communication controller 144 sets “1” in the PwrMgt field and transmits a BlockAck frame to the mobile phone 101 (step S31).

2.2 Operation of Mobile Phone 101

Next, an operation of the mobile phone 101 will be explained with reference to FIG. 9. FIG. 9 is a flowchart to explain the flow of operation of the mobile phone 101.

As shown in FIG. 9, in the flowchart of FIG. 6 in the first embodiment, when the PwrMgt field of the received BlockAck frame has “1” in it (YES in step S22), the mobile phone 101 checks the Duration field (step S33), and transitions to and remains in the transmission standby state until the period set in the Duration field has elapsed (step S23 and NO in step S34). If the period has expired (YES in step S34), the mobile phone 101 clears the transmission standby state.

### 2.3 Concrete Example of Operations

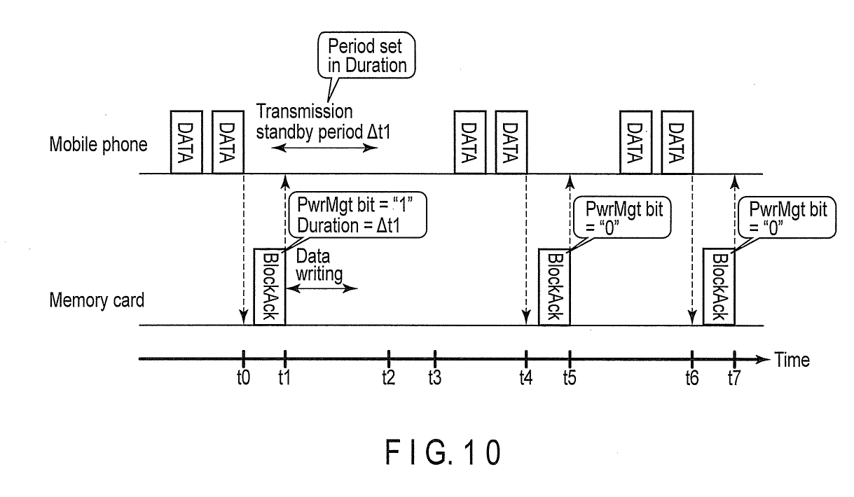

A concrete example of the operations of the mobile phone 101 and memory card 103 will be explained with reference to FIG. 10. Like FIG. 7 of the first embodiment, FIG. 10 shows a frame sequence when the wLAN device embedded in the mobile phone transmits two data frames in three bursts and the wireless communication unit 140 embedded in the memory card 103 receives the data frames.

As shown in FIG. 10, suppose, when two data frames were received at time t0, the free space of the buffer memory 141 of the memory card 103 has decreased below the specific value. Then, the communication controller 144 of the memory card 103 calculates how long transmission must be delayed to make the free space of the buffer memory 141 equal to or larger than the specific value. Then, the communication controller 144 sets the obtained period Δt1 in the Duration field and “1” in the PwrMgt field and transmits the BlockAck frame to the mobile phone 101 at time t1. This inhibits the mobile phone 101 from transmitting data to the memory card 103.

The mobile phone 101 stops transmitting data frames to the memory card 103 from when having received a BlockAck frame until period Δt1 stored in the Duration field has expired. In the meantime, the memory card 103 transfers data from the buffer memory 141 to the nonvolatile memory 130.

When period Δt1 has expired, the mobile phone 101 starts transmitting data frames to the memory card 103 again without receiving a QoS-Null frame and transmitting an ACK frame for the QoS-Null frame.

Suppose in the memory card 103 that received two data frames at time t4, the free space of the buffer memory 141 is equal to or larger than the specific value at this time. Then, the memory card 103 sets “0” in the PwrMgt field and transmits a BlockAck frame to the mobile phone 101 at time t5 without setting a transmission standby period in the Duration field. Since the PwrMgt field has a “0” in it, the mobile phone 101 continues transmitting data frames to the memory card 103 without changing to the transmission standby state.

### 3. Effect of the Second Embodiment

As described above, with the configuration of the second embodiment, more efficient access can be provided than in the first embodiment. This effect will be explained below.

In the configuration of the second embodiment, the length of a transmission standby period is set in the Duration field of a frame (a BlockAck frame in this example) for causing the transmitter of data frames to prohibit transmission. Therefore, when having received the frame, the transmitter of the data frames can know when it can start transmitting data frames again. Therefore, the exchange of a QoS-Null frame with an ACK frame in the first embodiment becomes unnecessary. As a result, more efficient access can be achieved.

Estimating the time required to clear the transmission standby period amounts to estimating how long it takes for the space of the buffer memory 141 to become free. Therefore, for example, the time required to write data of a write unit size into the nonvolatile memory 130 may be set in the communication controller 144 in advance. Of course, the calculation process may be performed by the card controller 120, not by the communication controller 144. The time also may be held by the card controller 120.

In the second embodiment, use of the PwrMgt field may be omitted. That is, the PwrMgt field may not be used, provided that there is an agreement that, when a transmission-acknowledge frame (a BlockAck frame in the second embodiment) in which a transmission standby period is set in the Duration field has been received, a communication terminal at the destination of the transmission-acknowledge frame goes to the transmission standby state. In this case, to cause the communication terminal to be in the transmission standby state, the standby period is stored in the Duration field. To cause the communication terminal to remain in the transmission state, zero is set in the Duration field.

### Third Embodiment

Next, a memory device and a method of controlling the memory device according to a third embodiment will be explained. The third embodiment is a combination of the first and second embodiments. Hereinafter, only what differs from the first and second embodiments will be explained.

### 1. Configuration

The configuration of a memory card 103 is as shown in FIG. 2 explained in the first embodiment. The third embodiment differs from the first embodiment only in the following points:
When the free space of the buffer memory 141 is less than a specific value, a communication controller 144 determines whether to set the length of a transmission standby period in a Duration field.
The communication controller 144 performs the processes in the second embodiment when setting the length of a transmission standby period in the Duration field and performs the processes in the first embodiment when not setting the length (or when it cannot set the length (e.g., when it cannot calculate a transmission standby period)).

### 2. Operation

Next, operations of a memory card 103 and a mobile phone 101 will be explained below, taking as an example a case where the mobile phone 101 acts as a transmitter and the memory card 103 acts as a receiver as in the first embodiment.

2.1 Operation of Memory Card 103

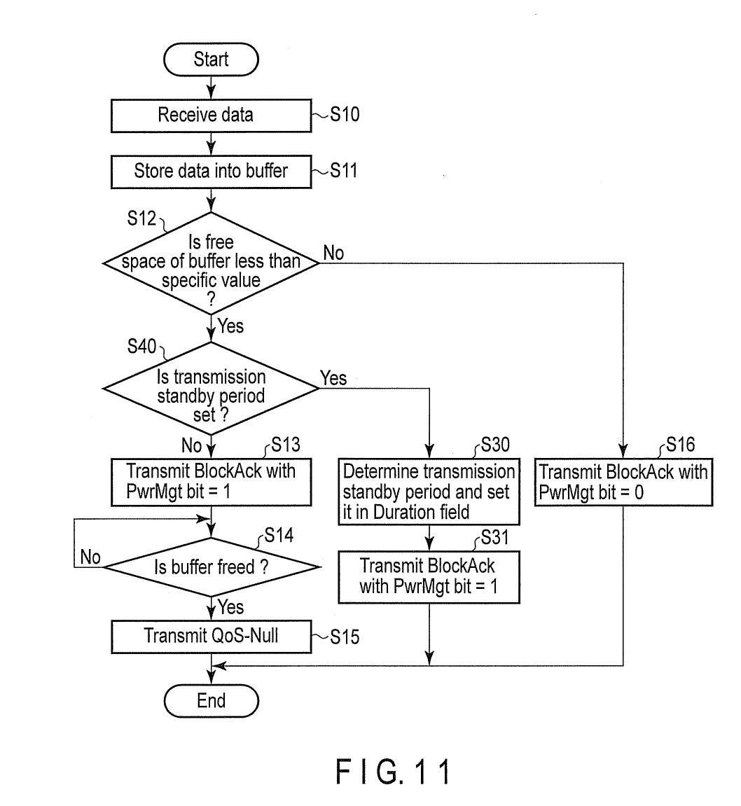

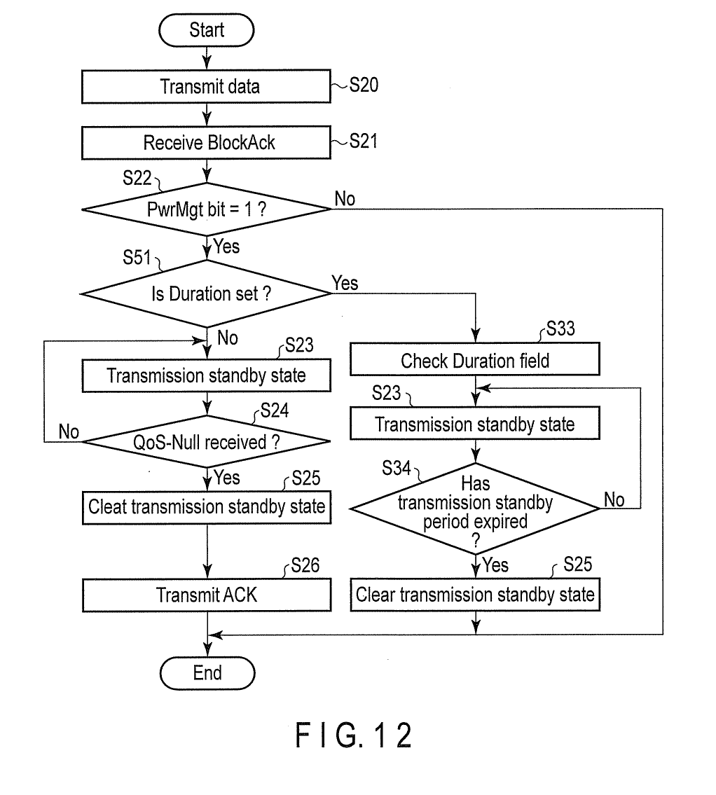

First, an operation of the memory card 103 will be explained with reference to FIG. 11. FIG. 11 is a flowchart to explain the flow of operation of the memory card 103.

As shown in FIG. 11, after steps S10, S11, if the free space of the buffer memory 141 is less than a specific value (YES in step S12), the communication controller 144 determines whether to set a transmission standby period in the Duration field, that is, whether to inform the mobile phone 101 of a transmission standby period. If not setting the transmission standby period (NO in step S40), the communication controller 144 performs the processes in steps S13 to S15 explained in the first embodiment. If setting the transmission standby period (YES in step S40), the communication controller 144 performs the processes in steps S30, S31 explained in the second embodiment.

2.2 Operation of Mobile Phone 101

Next, an operation of the mobile phone 101 will be explained with reference to FIG. 11. FIG. 11 is a flowchart to explain the flow of operation of the mobile phone 101.

As shown in FIG. 11, after steps S20, S21, if the PwrMgt field of the received BlockAck frame has “1” in it (YES in step S22), the mobile phone 101 checks whether the Duration field has been set. If it has not been set (NO in step S51), the mobile phone 101 performs the processes in steps S23 to S26 explained in the first embodiment. If it has been set (YES in step S51), the mobile phone 101 performs the processes in step S33 and forward explained in the second embodiment.

2.3 Concrete Example of Operations

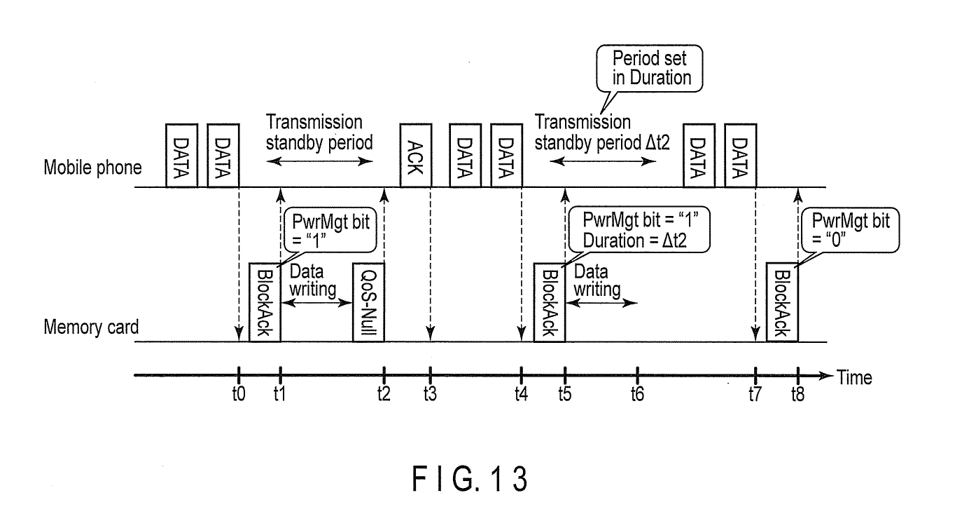

A concrete example of operations of the mobile phone 101 and memory card 103 will be explained with reference to FIG. 13. Like FIG. 7 of the first embodiment, FIG. 13 shows a frame sequence when the wLAN device embedded in the mobile phone transmits two data frames in three bursts and the wireless communication unit 140 embedded in the memory card 103 receives the data frames.

As shown in FIG. 13, suppose, when two data frames were received at time t0, the free space of the buffer memory 141 has decreased below the specific value. At this time, for some reason, the length of a transmission standby period to be set could not be measured. In this case, the communication controller 144 sets “1” in the PwrMgt field without setting a transmission standby period in the Duration field and transmits a BlockAck frame. Then, when the free space of the buffer memory 141 has become sufficient, the communication controller 144 transmits a QoS-Null frame.

When a data frame was received at time t4, suppose the free space of the buffer memory 141 has decreased below the specific value and the length of a transmission standby period to be set can be estimated. In this case, the communication controller 144 sets a transmission standby period in the Duration field, sets “1” in the PwrMgt field, and transmits a BlockAck frame. In this case, a QoS-Null frame need not be transmitted.

### 3. Effect of the Third Embodiment

With the configuration of the third embodiment, a method of causing a transmitter of data frames to set in the transmission standby period can be selected arbitrarily according to the situation. Accordingly, it is possible to communicate with various terminals and improve the freedom in system design.

### Fourth Embodiment

Next, a memory device and a method of controlling the memory device according to a fourth embodiment will be explained. The memory device according to the fourth embodiment is such that a BlocAck frame to be transmitted by a memory card 103 is extended to notify the number of data frames the memory card 103 can receive to mobile phone 101. Hereinafter, only what differs from the first embodiment will be explained.

### 1. Configuration

The configuration of a memory card 103 is as shown in FIG. 2 explained in the first embodiment. The fourth embodiment differs from the first embodiment only in the following points:
When the free space of the buffer memory 141 is equal to or larger than a specific value, the communication controller 144 calculates, according to the free space, the number of data frames that can be received after having transmitted a BlockAck frame.
When the free space of the buffer memory 141 is less than the specific value, the communication controller 144 calculates, according to the free space, the number of data frames that can be received after a transmission standby period of the mobile phone 101 has elapsed.
A Remaining Buffer field is added to a BlockAck frame to the mobile phone 101 for transmission-acknowledge and the number of calculated data frames is set in the Remaining Buffer field.

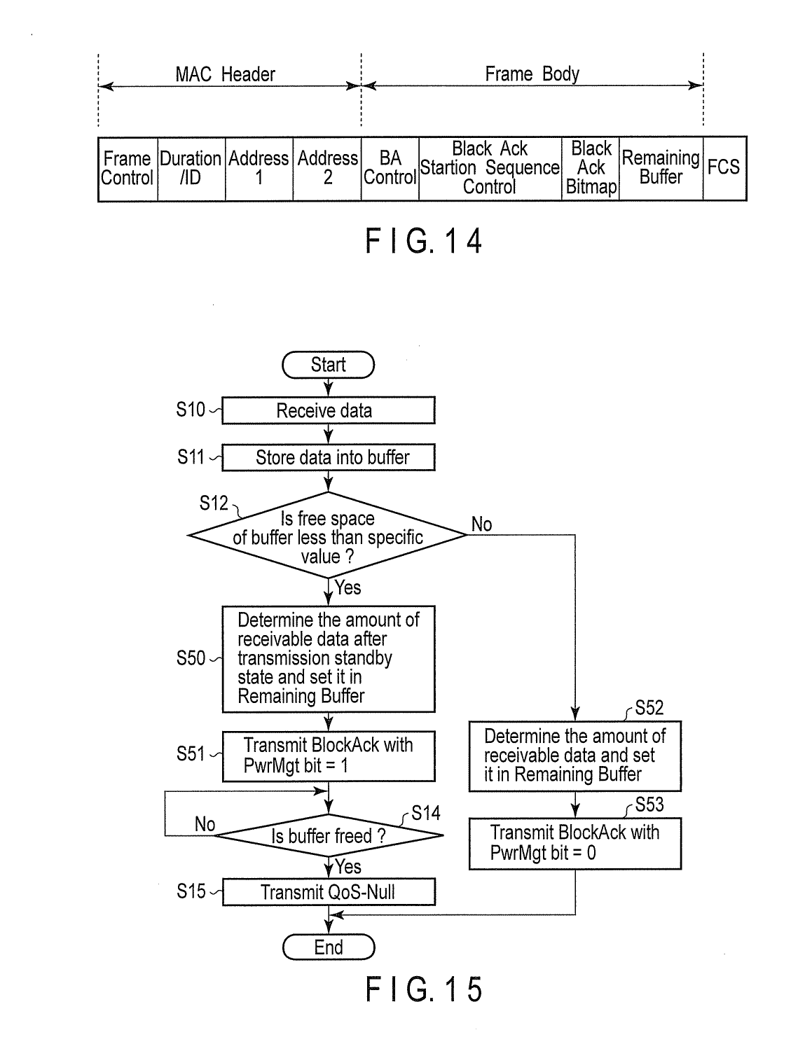

FIG. 14 is a schematic view of a BlockAck frame to which a Remaining Buffer field has been added. Hereinafter, this frame is called an extended BlockAck frame. As shown in FIG. 14, in a frame body, a Remaining Buffer field is provided. In the Remaining Buffer field, information on the remaining capacity of the buffer memory 141 is stored. In the fourth embodiment, although a unit of Remaining Buffer field is expressed as the number of data frames, the unit may be expressed as units of Kbytes or as a data size that can be received.

### 2. Operation

Next, operations of the memory card 103 and mobile phone 101 will be explained below, taking as an example a case where the mobile phone 101 acts as a transmitter and the memory card 103 acts as a receiver as in the first embodiment.

### 2.1 Operation of memory card 103

First, an operation of the memory card 103 will be explained with reference to FIG. 15. FIG. 15 is a flowchart to explain the flow of operation of the memory card 103.

As shown in FIG. 15, in the flowchart explained with reference to FIG. 5 of the first embodiment, if the free space of the buffer memory 141 is less than the specific value (YES in step S12), the communication controller 144 causes the mobile phone 101 to transitions to the transmission standby state, determines the number of receivable data frames, and sets the number in the Remaining Buffer field (step S50).

Then, the communication controller 144 sets “1” in the PwrMgt field and transmits an extended BlockAck frame to the mobile phone 101 (step S51). Thereafter, the communication controller 144 performs steps S14 and S15 as in the first embodiment.

If the free space of the buffer memory 141 is equal to or larger than the specific value (NO in step S12), the communication controller 144 determines the number of receivable data frames after having transmitted the extended BlockAck frame, and sets the number in the Remaining Buffer field (step S52)

Then, the communication controller 144 sets “0” in the PwrMgt field and transmits an extended BlockAck frame to the mobile phone 101 (step S53).

If “0” is set in the Remaining Buffer field, the mobile phone 101 may be allowed to determine the number of data frames.

### 2.2 Operation of Mobile Phone 101

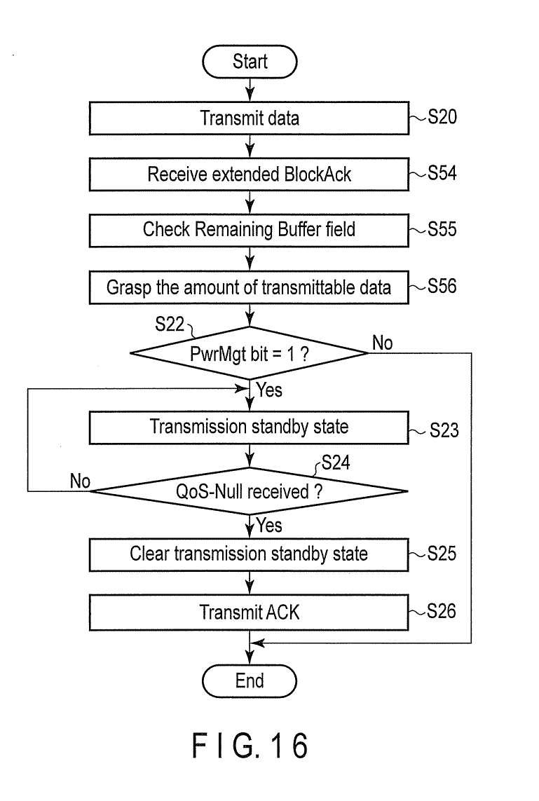

Next, an operation of the mobile phone 101 will be explained with reference to FIG. 16. FIG. 16 is a flowchart to explain the flow of operation of the mobile phone 101.

As shown in FIG. 16, having received the extended BlockAck frame (step S54), the mobile phone 101 checks the Remaining Buffer field (step S55), thereby grasping the number of data frames that can be transmitted next (step S56).

Thereafter, the processes in steps S22 to S26 are performed as in the first embodiment. In the next transmission, the mobile phone 101 transmits data frames up to the value set in the Remaining Buffer field of the latest received extended BlockAck frame. If the Remaining Buffer field has “0” in it, the mobile phone 101 may determine the number of data frames to be transmitted.

### 2.3 Concrete Example of Operations

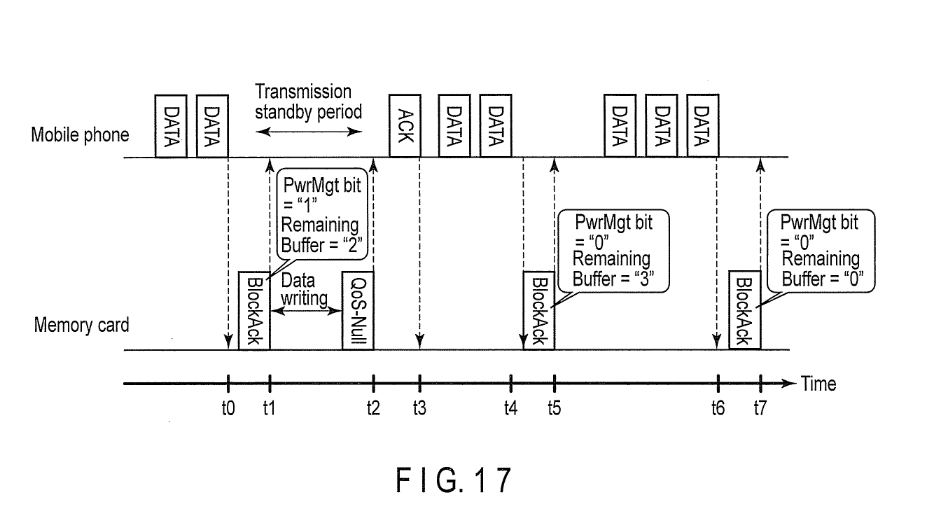

A concrete example of operations of the mobile phone 101 and memory card 103 will be explained with reference to FIG. 17. Like FIG. 7 of the first embodiment, FIG. 17 shows a frame sequence when the wLAN device embedded in the mobile phone transmits data frames to the wireless communication unit 140 embedded in the memory card 103.

As shown in FIG. 17, suppose, when two data frames were received at time t0, the free space of the buffer memory 141 has decreased below a specific value. Then, the communication controller 144 of the memory card 103 calculates the number of data frames that can be received by the buffer memory 141 after a transmission standby period on the basis of the relationship between the transmission standby period and the speed for writing data into the nonvolatile memory 130. Suppose the calculation result has shown that the number of receivable data frames is two. Then, the communication controller 144 sets “2” in the Remaining Buffer field and “1” in the PwrMgt field and transmits an extended BlockAck frame to the mobile phone 101 at time t1. This inhibits the mobile phone 101 from transmitting data to the memory card 103.

Thereafter, when a QoS-Null frame and an ACK frame clear the transmission standby state, the mobile phone transmits as many data frames as up to two set in the Remaining Buffer field of the extended BlockAck frame received at time t1 (in FIG. 17, two data frames are transmitted).

Suppose when two data frames were received at time t4, suppose the free space of the buffer memory 141 is equal to or larger than the specific value. Then, the communication controller 144 calculates the number of data frames that can be received by the buffer memory 141 after having transmitted an extended BlockAck frame on the basis of the availability (that is, free space) of the buffer memory 141. Suppose the calculation result has shown that the number of receivable data frames is, for example, three. Then, the communication controller 144 sets “3” in the Remaining Buffer field and “0” in the PwrMgt field and transmits an extended BlockAck frame to the mobile phone 101 at time t5.

Then, the mobile phone transmits as many data frames as up to three set in the Remaining Buffer field of the extended BlockAck frame received at time t5 (in FIG. 17, three data frames are transmitted).

### 3. Effect of the Fourth Embodiment

As described above, the configuration of the fourth embodiment enables more efficient access than that of the first embodiment. This effect will be explained.

In the configuration of the fourth embodiment, the Remaining Buffer field indicating the number of receivable data frames is added to a BlockAck frame by extending a conventional BlockAck frame. Then, use of the extended BlockAck frame makes it possible to inform a transmitter of the maximum number of transmittable data frames.

As a result, at a receiver, the free space of the buffer memory hardly decreases below the specific value. Therefore, the opportunity for a transmission standby period to be set in the transmitter decreases and therefore the necessity for exchange of frames between a QoS-Null frame and an ACK frame also decreases. Accordingly, efficient data communication can be performed.

### 4. Modifications of the Fourth Embodiment

Hereinafter, modifications of the fourth embodiment will be explained.

### 4.1 First Modification

While in the fourth embodiment, a PwrMgt field has been provided in an extended BlockAck frame, the PwrMgt field may be eliminated. In this case, the value in the Remaining Buffer field indicates the remaining capacity of the buffer memory 141. When the Remaining Buffer field has zero in it, the mobile phone 101 transition to the transmission standby state. The number of data frames to be transmitted after the QoS-Null frame and ACK frame clear the transmission standby state is determined by, for example, the mobile phone 101.

### 4.2 Second Modification

In the fourth embodiment and the first modification, exchange between the QoS-Null frame and ACK frame may be eliminated. This is because it is conceivable that use of the Remaining Buffer field remarkably decreases the possibility that the remaining capacity of the buffer memory 141 will decrease below the specific value. In this case, the length of the transmission standby period is determined by, for example, the mobile phone 101.

### 4.3 Third Modification

In the fourth embodiment and the first and second modifications, the length of the transmission standby period may be set in the Duration field of the extended BlockAck frame. The reason for this is as explained in the second and third embodiments.

### Fifth Embodiment

Next, a memory device and a method of controlling the memory device according to a fifth embodiment will be explained. The fifth embodiment is such that, when the memory card 103 is accessed by the television 102, the memory card instructs the mobile phone 101 to transition to the transmission standby state in the first to fourth embodiments. Hereinafter, only what differs from the first to fourth embodiments will be explained.

### 1. Operation of Memory Card 103

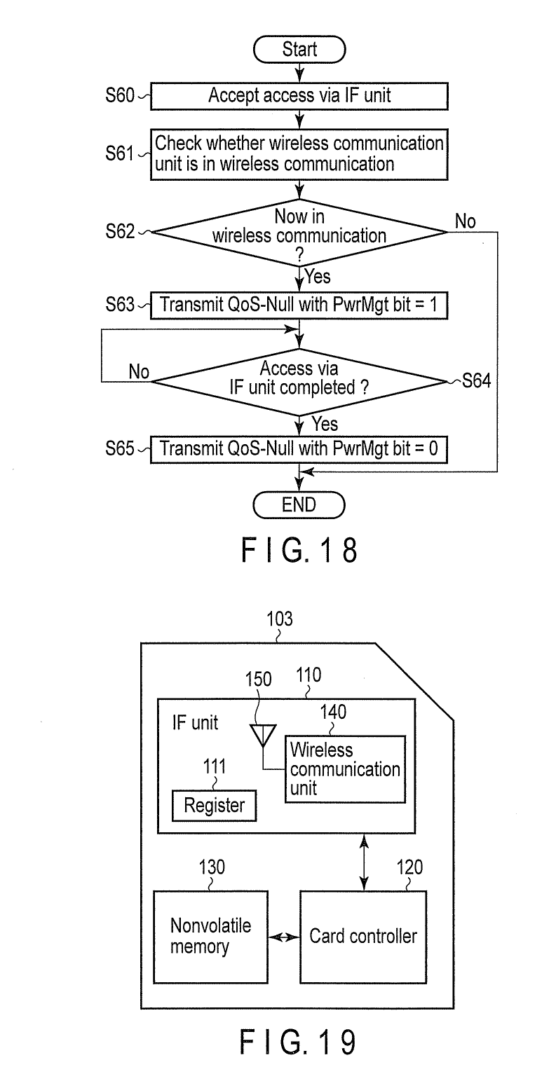

FIG. 18 is a flowchart to explain an operation of the memory card 103 according to the fifth embodiment.

As shown in FIG. 18, when the memory card 103 is accessed by the television 102 via the IF unit 110 (i.e., when the television 102 writes or reads data into or from the memory card 103), the IF unit 110 accepts this (step S60). In response to the acceptance of access at the IF unit 110, the card controller 120 checks whether the wireless communication unit 140 is communicating with the mobile phone 101 by wireless (step S61).

If the wireless communication unit 140 is in wireless communication (YES in step S62), the card controller 120 not only informs the wireless communication unit 140 that the nonvolatile memory 130 is in a busy state but also instructs the wireless communication unit 140 to cause the mobile phone 101 to transition to the transmission standby state. That is, the wireless communication unit 140 sets “1” in the PwrMgt field to generate a QoS-Null frame and transmits the QoS-Null frame to the mobile phone 101 (step S63). This inhibits the mobile phone 101 from transmitting data to the memory card 103.

Thereafter, when the television 102 completes the access to the nonvolatile memory 130 (YES in step S64), the card controller 120 instructs the wireless communication unit 140 to clear the transmission standby state of the mobile phone 101. That is, the wireless communication unit 140 sets “0” in the PwrMgt field to generate a QoS-Null frame and transmits the QoS-Null frame to the mobile phone 101 (step S65). This makes the mobile phone 101 start transmitting data to the memory card 103 again.

### 2. Effect of the Fifth Embodiment

The memory card 103 of the fifth embodiment includes a plurality of interfaces to be connected with the outside. That is, one is the IF unit 110 for wired connection and the other is the wireless communication unit 140 for wireless connection. That is, the memory card 103 is accessed by a plurality of host devices.

Depending on circumstances, the memory card 103 might be accessed by a plurality of host devices at the same time. For example, suppose, while the television 102 is accessing the memory card 103, the mobile phone 101 transmits data to the memory card 103. Since the memory card 103 is already in the busy state, the data transmitted from the mobile phone 101 is not written into the nonvolatile memory 130 and might be discarded.

However, with the configuration of the fifth embodiment, when having accepted access from the television 102, the memory card 103 stops wireless communication temporarily. That is, during the time when the memory card 103 is accepting access from a host device, it does not accept access from another host device. In this way, priority is given to the process of dealing with the host device that accessed the card 103 earlier, preventing data from being transmitted again uselessly, which enables efficient communication.

If the access time of the television 102 can be estimated, the mobile phone 101 may be informed of the length of a transmission standby period as in the second embodiment. Alternatively, the Remaining Buffer field may be used as in the fourth embodiment.

While in the fifth embodiment, priority has been given to access from the IF unit 110, priority may be given to the wireless communication unit 140. That is, when the memory card 103 has accepted access from the television 102 via the IF unit 110, while the memory card 103 is communicating wirelessly with the mobile phone 101 via the wireless communication unit 140, the card controller 120 may inform the television 102 via the IF unit 110 that the memory card 103 is in the busy state. This prevents the television 102 from transferring data during wireless communication.

While the fifth embodiment has been explained on the assumption that the configurations of the first to fourth embodiment are used, the fifth embodiment may be implemented independently.

### Sixth Embodiment

Next, a memory device and a method of controlling the memory device according to a sixth embodiment will be explained. The sixth embodiment is such that the IF unit 110 is configured to operate wirelessly in the first to fifth embodiments. Hereinafter, only what differs from the first to fifth embodiments will be explained.

### 1. Configuration of Memory Card 103

FIG. 19 is a block diagram of a memory card 103 according to the sixth embodiment. As shown in FIG. 19, the memory card 103 of the sixth embodiment is such that a wireless communication unit 140 is incorporated in an IF unit 110 in the configuration of FIG. 2 explained in the first embodiment. In other words, it may be said that the wireless communication unit 140 is eliminated and the IF unit is configured to operate wirelessly in FIG. 2. Alternatively, it may be said that the IF unit 110 is eliminated and the wireless communication unit 140 is configured to have the function of the IF unit 110 in FIG. 2.

### 2. Configuration of Memory Card 103

In FIG. 19, the wireless communication unit 140 communicates not only with the mobile phone 101 but also with the television 102. When communicating with the television 102, the wireless communication unit 140 causes the television 102 to prohibit a transmission of a data frame by using at least one of the PwrMgt field, Duration field, and Remaining field.

### 3. Effect of the Sixth Embodiment

As described above, all the interfaces of the memory card 103 may be configured to operate wirelessly. The sixth embodiment may be implemented independently without the assumption that the first to fifth embodiments are used.

### Seventh Embodiment

Next, a memory device and a method of controlling the memory device according to a seventh embodiment will be explained. The seventh embodiment relates to another method of determining whether to cause the mobile phone 101 to transition to the transmission standby state in the first embodiment. Hereinafter, only what differs from the first embodiment will be explained.

### 1. Configuration of Memory Card 103

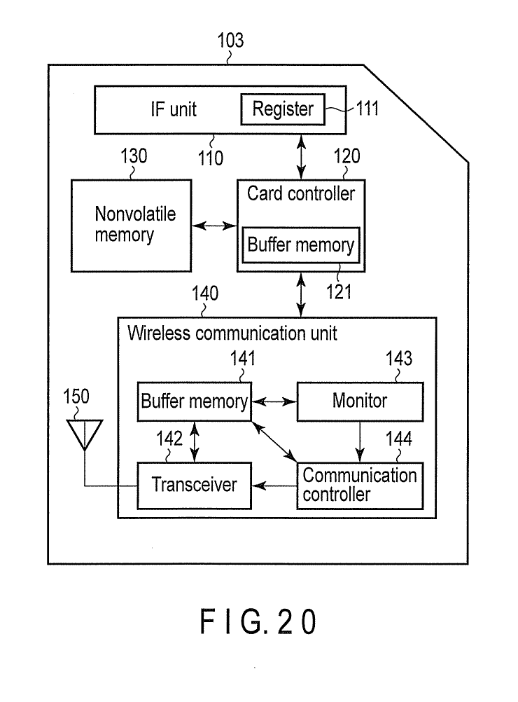

FIG. 20 is a block diagram of a memory card 103 according to the seventh embodiment. As shown in FIG. 20, the memory card 103 of the seventh embodiment is such that the card controller 120 is provided with a buffer memory 121 in FIG. 2 explained in the first embodiment.

Data received by the wireless communication unit 140 in wireless communication is first stored in the buffer memory 141 and then transferred to the buffer memory 121. Then, the card controller 120 stores the data in the buffer memory 121 into the nonvolatile memory 130.

The communication controller 144 determines whether to cause the mobile phone 101 to transition to the transmission standby state based on not only the free space of the buffer memory 141 but also an increase in the free space by transferring the data in the buffer memory 141 to the buffer memory 121 and the time required for the mobile phone 101 to transmit a next data frame. An operation of the communication controller 144 will be explained in detail below.

### 2. Operation of Memory Card 103

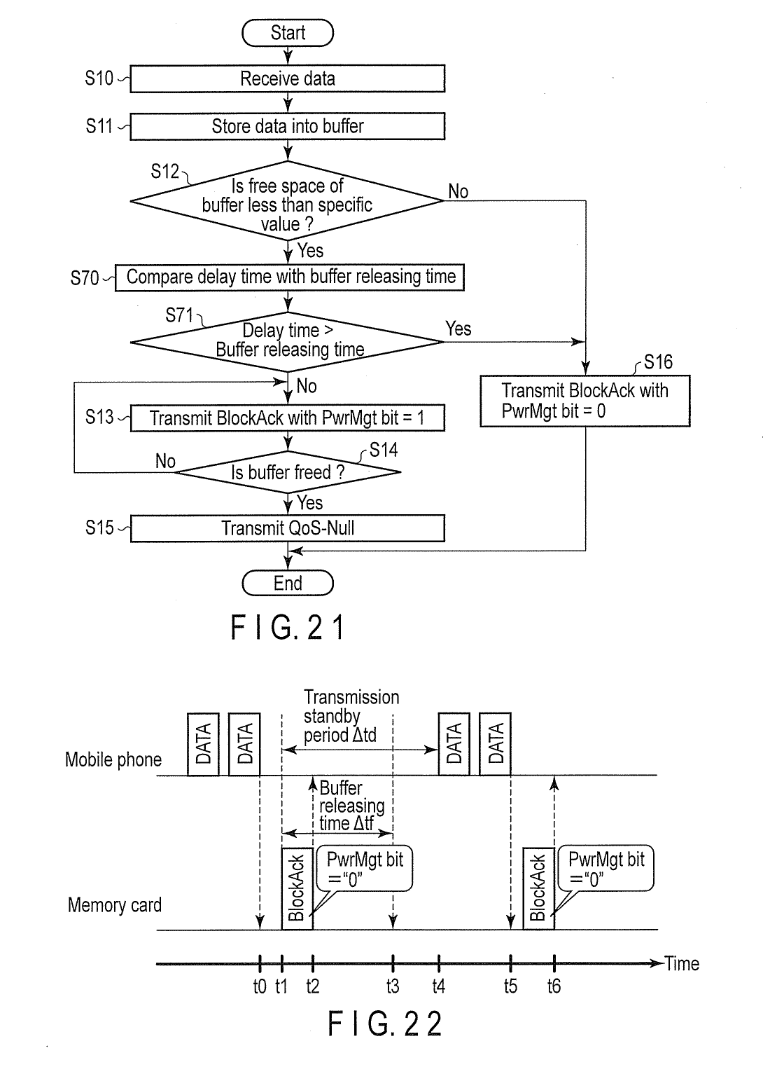

FIG. 21 is a flowchart to explain an operation of the memory card 103.

As shown in FIG. 21, if the free space of the buffer memory 141 is less than the specific value (YES in step S12), the communication controller 144 compares a delay time with a buffer releasing time (step S70). The delay time is the time required for the mobile phone 101 to transmit a data frame since the memory card 103 started to transmit a BlockAck frame. The delay time can be calculated statistically by the communication controller 144. The buffer releasing time is the time required to transfer data in the buffer memory 141 to the television 102 via the buffer memory 121 of the card controller 120 and/or the IF unit 110. In other words, the buffer releasing time is the time required for the free space of the buffer memory 141 to increase to a specific value or more from the present.

Then, if the delay time is equal to or shorter than the buffer releasing time (NO in step S71), the communication controller 144 goes to step S13 and causes the mobile phone 101 to transition to the transmission standby state. If the delay time is longer than the buffer releasing time (YES in step S71), the communication controller 144 determines that a sufficient free space can be secured in the buffer memory 141 by the time data frames will be actually received, though the free space of the buffer memory 141 is not sufficient at present. Therefore, the communication controller 144 goes to step S16 and continues communicating wirelessly with the mobile phone 101 without causing the mobile phone 101 to transition to the transmission standby state.

FIG. 22 shows a frame sequence when the wLAN device embedded in the mobile phone transmits data to the wireless communication unit 140 embedded in the memory card 103 as in FIG. 7 of the first embodiment.

As shown in FIG. 22, suppose, when two data frames were received at time t0, the free space of the buffer memory 141 has decreased below the specific value. Then, the communication controller 144 estimates a delay time Δtd and a buffer releasing time Δtf and compares them. Suppose the comparison result has shown that delay time Δtd>buffer releasing time Δtf. Then, the communication controller 144 sets “0” in the PwrMgt field and transmits a BlockAck frame to the mobile phone 101 at time t2. This enables the mobile phone 101 to continue transmitting data frames to the memory card 103.

### 3. Effect of the Seventh Embodiment

The configuration of the seventh embodiment enables more efficient communication to be performed than that of the first embodiment. This effect will be explained below.

Data received by the antenna 150 is first stored in the buffer memory 141. This data does not stay in the buffer memory 141 indefinitely. For example, the data is transferred to the buffer memory 121 so as to be written into the nonvolatile memory 130 or is transferred to the television 120.

Then, even if the free space of the buffer memory 141 is running short, the shortage of the free space of the buffer memory 141 will be solved very soon, provided that data in the buffer memory 141 is immediately transferred to the buffer memory 121 or television 102.

Therefore, in the seventh embodiment, if it is predicted that the shortage of the free space of the buffer memory 141 will be eliminated at the time when a data frame is transferred next, the mobile phone 101 is not inhibited from transmitting the data even though the free space of the buffer memory 141 is less than the specific value at present. Specifically, if delay time Δtd>buffer releasing time Δtf, it can be determined that the free space shortage will be eliminated very soon.

Consequently, the mobile phone 101 need not be inhibited from transmitting for longer than is necessary, enabling more efficient communication.

While the seventh embodiment has been applied to the first embodiment, it may be applied to the second to fifth embodiments similarly. For example, when the seventh embodiment is applied to the second embodiment, the processes in steps S70 and S71 are performed after YES in step S12 of FIG. 8. If delay time Δtd>buffer releasing time Δtf, control proceeds to step S16. If not, control proceeds to step S30. For example, when the seventh embodiment is applied to the fourth embodiment, the processes in steps S70 and S71 are performed after YES in step S12 of FIG. 15. If delay time Δtd>buffer releasing time Δtf, control proceeds to step S52. If not, control proceeds to step S50.

### Eighth Embodiment

Next, a memory device and a method of controlling the memory device according to an eighth embodiment will be explained. The eighth embodiment corresponds to a more detailed concrete example of the seventh embodiment.

### 1. Configuration of Memory Card

### 1.1 Overall Configuration of Memory Card

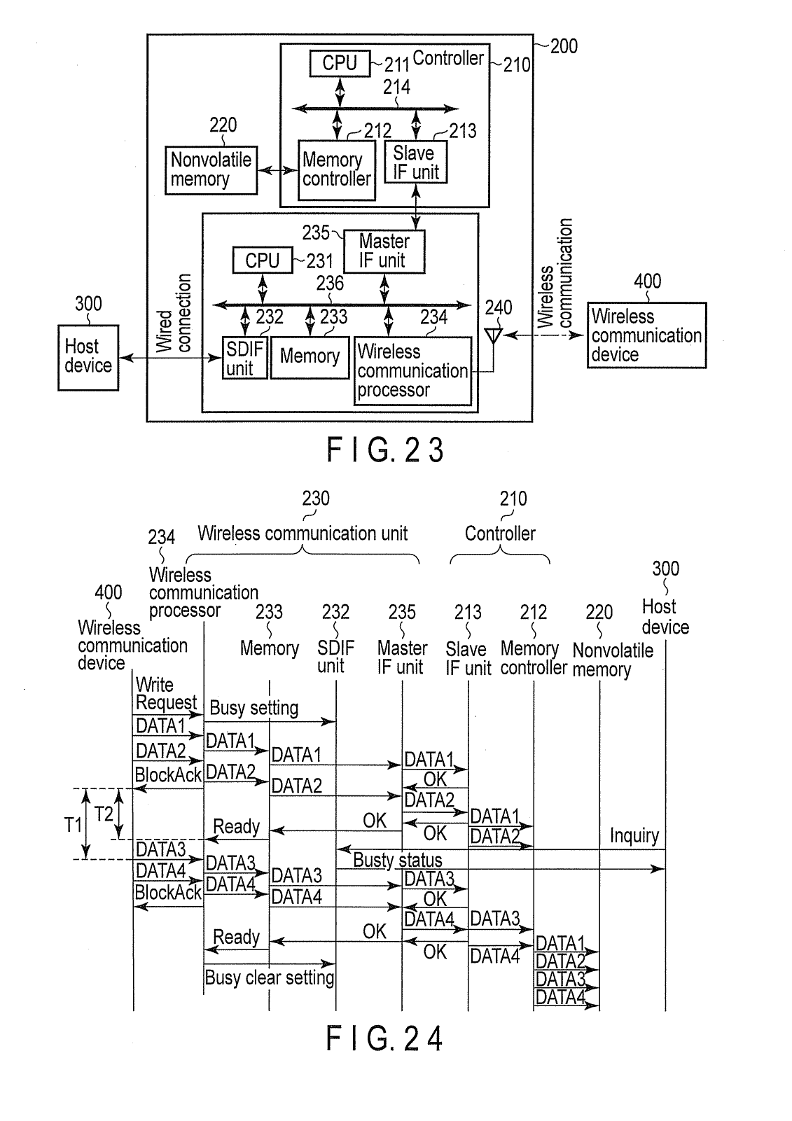

FIG. 23 is a block diagram of a memory card 200 according to the eighth embodiment. As shown in FIG. 23, the memory device 200 is connected to a host device 300 by wired connection. The host device 300 supplies electric power to the memory device 200. An interface standard used between the memory device 200 and the host device 300 is such a standard as corresponds to, for example, the SD standard (including the SD memory interface standard and the SDIO interface standard) or the USB standard.

The memory device 200 can be connected wirelessly to a wireless communication device 400. The wireless communication system may be configured to comply with the IEEE 802.11 (including IEEE 802.11a, IEEE 802.11b, IEEE 802.11g, and IEEE 802.11n) standard or another wireless communication standard.

The memory card 200 includes a controller 210, a nonvolatile memory 220, a wireless communication unit 230, and an antenna 240.

The wireless communication unit 230 has the function of communicating with the wireless communication device 400 by wireless and communicating with the host device 300 by wired connection.

The controller 210 is connected with the nonvolatile memory 220 and wireless communication unit 230. The controller 210 writes data supplied from the wireless communication unit 230 into the nonvolatile memory 220 and transfers data read from the nonvolatile memory 220 to the wireless communication unit 230.

The nonvolatile memory 220 is a memory that continues holding data even if the power supply to the memory card 200 is stopped. The nonvolatile memory 220 is, for example, a NAND flash memory.

1.2 Configuration of Wireless Communication Unit 230

Next, a configuration of the wireless communication unit 230 will be explained with reference to FIG. 23. As shown in FIG. 23, the wireless communication unit 230 includes a CPU 231, an SD interface unit (SDIF unit) 232, a memory 233, a wireless communication processor 234, a master interface unit (master IF unit) 235, and a bus 236.

The wireless communication processor 234 transmits and receives data via the antenna 240 according to the IEEE 802.11 (including IEEE 802.11a, IEEE 802.11b, IEEE 802.11g, and IEEE 802.11n) standard. The wireless communication processor 234 transmits data read from the memory 233 to the wireless communication device 400 and writes data received from the wireless communication device 400 into the memory 233.

The SDIF unit 232 transfers data to the host device 300 according to the SD standard (including the SD memory interface standard and the SDIO interface standard). The SDIF unit 232 transmits data read from the memory 233 to the host device 300 and writes data received from the host device 300 into the memory 233.

The memory 233 temporarily stores data exchanged between the SDIF unit 232 and wireless communication processor 234. The memory 233 is, for example, a semiconductor memory, such as a DRAM or an SRAM. Here, suppose a capacity for storing frames in the memory 233 of the eighth embodiment is as large as corresponds to, for example, two DATA frames.

The master IF unit 235 has an interface function of exchanging data with the controller 210. According to, for example, an instruction from the CPU 231, the master IF unit 235 transfers data stored in the memory 233 to the controller 210 or reads data stored in the nonvolatile memory 220 via the controller 210.

The CPU 231 controls the operation of the entire wireless communication unit 230. That is, the CPU 231 controls each block in the wireless communication unit 230, calculates the time required for data stored in the memory 233 to be transferred to the controller 210 via the master IF unit 235, or sets a state indicating “now in wireless communication” in the SDIF unit 232 when wireless connection is established.

The bus 236 connects the aforementioned functional blocks in such a manner that they can communicate with one another.

### 1.3 Configuration of Controller 210

Next, the configuration of the controller 210 will be explained with reference to FIG. 23. As shown in FIG. 23, the controller 210 includes a CPU 211, a memory controller 212, a slave interface unit (slave IF unit) 213, and a bus 214.

The memory controller 212 has the function of writing, reading, and erasing data into, from, and from the nonvolatile memory 220. The memory controller 212 writes data transferred from the wireless communication unit 230 into the nonvolatile memory 220 and transfers data read from the nonvolatile memory 220 to the wireless communication unit 230. Therefore, the memory controller 212 includes an internal buffer (not shown) for, for example, at least one page (four DATA frames in the eighth embodiment).

The slave IF unit 213 has an interface function of exchanging data with the wireless communication unit 230. By request of, for example, the master IF unit 235, the slave IF unit 213 transfers received data to the memory controller 212 or transmits data transferred from the memory controller 212 to the master IF unit 235.

The CPU 211 controls the operation of the entire controller 210.

The bus 214 connects the aforementioned functional blocks in such a manner that they can communicate with one another.

### 1.4 Correspondence Relationship Between the Eighth Embodiment and the First to Seventh Embodiments

The first to seventh embodiments and the eighth embodiment have, for example, the following relationship. The memory card 103, television 102, and mobile phone 101 correspond to the memory card 200, host device 300, and wireless communication device 400 in FIG. 23, respectively.

The IF unit 110, card controller 120, nonvolatile memory 130, and wireless communication unit 140 correspond to the SDIF unit 232, controller 210, nonvolatile memory 220, and wireless communication unit 230 excluding the SDIF unit 232, respectively.

The buffer memory 141 and transceiver 142 correspond to the memory 233 and wireless communication processor 234, respectively. The monitor 143 and communication controller 144 correspond to the CPU 231.

The buffer memory 121 corresponds to the slave IF unit 213.

### 2. Operation of Memory Card 200

2.1 Overall Flow of Data Communication

Next, an operation of the memory card 200 according to the eighth embodiment will be explained with reference to FIG. 24. FIG. 24 is a sequence diagram to explain the exchange of signals and data between each block in the memory card 200, host device 300, and wireless communication device 400.

First, the wireless communication device 400 issues a Write Request to write data into the memory card 200 and transmits the request to the memory card 200. The Write Request is transmitted using one (e.g., a data frame) of the frames determined in the IEEE 802.11 standard. Suppose the Write request in FIG. 24 is a request for the transmission of four data frames, data frames DATA1 to DATA4.

Having received the Write Request, the wireless communication processor 234 sets information that the present status is a busy status in the SDIF unit 232. In this case, the SDIF unit 232 may inform the host device 300 explicitly that the present status is a busy status. Alternatively, when having received an inquiry from the host device 300, the SDIF unit 232 may return a busy status. This prevents the host device 300 from stopping the supply of electric power to the memory card 200 carelessly.

Then, the memory card 200 receives DATA1 and DATA2 from the wireless communication device 400. After a SIFS (Short Inter Frame Space) period has elapsed since DATA2 was received, the wireless communication processor 234 transmits BlockAck frame corresponding to DATA1 and DATA2 to the wireless communication device 400.

The wireless communication processor 234 transfers the received DATA1 and DATA2 to the memory 233. After the transfer, the wireless communication processor 234 informs the CPU 231 that it has received DATA1 and DATA2.

Then, under the control of the CPU 231, the master IF unit 235 reads DATA1 and DATA2 from the memory 233 and transfers them to the slave IF unit 213.

Having transferred DATA1 and DATA2, the master IF unit 235 informs the memory 233 of the success of the transfer. Thereafter, the memory 233 releases the memory area in which DATA1 and DATA2 were stored and informs the wireless communication processor 234 of a Ready state, meaning that data can be written.

Here, when the host device 300 inquires about the present state of the memory card 200, the SDIF unit 232 answers that the memory card 200 is in the busy status (in wireless communication).

Next, the wireless communication processor 234 receives DATA3 and DATA4 from the wireless communication device 400. At this time, the procedure for DATA3 and DATA 4 being transmitted from the wireless communication processor 234 to the memory controller 212 is the same as described above.

When data transferred to an internal buffer has accumulated to a specific amount, or when a Write-Request size of data has been transferred (when DATA1 to DATA4 have been accumulated in the internal buffer in the example of FIG. 24), the memory controller 212 writes the data into the mobile phone 220.

After being informed by the memory 233 of notice of being ready after the completion of the transfer of DATA3 and DATA4, the wireless communication processor 234 sets the SDIF unit 232 so as to clear the busy status.

### 2.2 Determining Whether to Cause the Wireless Communication Device 400 to Transition to the Transmission Standby State

Next, a determination of whether to cause the wireless communication device 400 to transition to the transmission standby state will be explained with reference to FIGS. 23 and 24. Hereinafter, for simplicity, suppose a case where the free space of the memory 233 decreases below a specific value when having stored DATA1 and DATA2.

Here, suppose an average value obtained by statistically observing the time from when the wireless communication processor 234 started to transmit a BlockAck frame until the processor 234 starts to receive DATA3 frame is T1 (corresponding to Δtd in the seventh embodiment). In addition, suppose the time from when the wireless communication processor 234 started to transmit a BlockAck frame until the memory 233 goes into the ready status (or until DATA1 and DATA2 are read from the memory 233 to release the memory area) is T2 (corresponding to Δtf in the seventh embodiment).

If T1>T2, the wireless communication processor 234 sets the PwrMgt bit of the BlockAck frame to “0” and transmits the BlockAck frame (the wireless communication processor 234 predicts that the area of the memory 233 will be released by the time DATA3 is received).

If T1≦T2, the wireless communication processor 234 sets the PwrMgt bit of the BlockAck frame to “1” and transmits the BlockAck frame (the wireless communication processor 234 predicts that the area of the memory 233 will not be released by the time DATA3 is received).

### 3. Effect of the Eighth Embodiment

The eighth embodiment produces the same effect as that of the seventh embodiment.

[Modifications]

As described above, the memory device 103 according to each of the first to eighth embodiments comprises the first interface 110, wireless communication unit 140, first memory 130, and second memory 141. The wireless communication unit 140 is capable of wireless communication. The first memory 130 can store data in a nonvolatile manner. The second memory 141 can temporarily store data received by the wireless communication unit 140. When the remaining capacity of the second memory 141 decreases below a first capacity, the wireless communication unit 140 transmits a first frame BlockAck to set a period during which data is no transferred to the wireless communication unit 140.

As a result, the transmitter 101 can be inhibited from transmission when the memory device 103 writes data received via a wireless channel into the nonvolatile memory 130. Therefore, the received data can be written efficiently into the nonvolatile memory 130 without being discarded on the memory device 103 side.

The above embodiments are illustrative and not restrictive and may be modified variously. For example, while in the embodiments, the buffer memory 141 has been included in the wireless communication unit 140, it may be included in the card controller 120 or in both the wireless communication unit 140 and the card controller 120. The buffer memory 141 functions as a primary memory for data received by wireless communication. The buffer memory 141 has a shorter latency required to start a read or a write operation than that of a memory functioning as a secondary memory (e.g., the nonvolatile memory 130 or buffer memory 121 of FIG. 20).

In the above embodiments, data frames have been aggregated and transmitted and, in response to this, a BlockAck frame has been transmitted. However, data frames are not necessarily aggregated. When they are not aggregated, the above embodiments may be implemented using a normal transmission-acknowledge frame (an ACK frame if the wireless communication system complies with the 802.11 standard).

Furthermore, while the television 102 and mobile phone 101 have been used as host devices, electronic devices other than these may be used as host devices. For instance, a digital video recorder, a digital camera, a notebook-size personal computer, or a personal digital assistant (PDA) may be used as a host device.

In addition, the memory device 103 is not limited to an SD card and may be another card device. Moreover, the nonvolatile memory 130 is not limited to a NAND flash memory and may be another semiconductor memory. The memory device 103 may be an SDIO card and is not limited to a storage device. That is, the memory device 103 is not limited to a storage device, provided that it has a wireless communication function and is configured to buffer data received wirelessly. Moreover, the memory device 103 is not limited to a card device.

Furthermore, the above embodiments may be combined variously if at all possible. In addition, each of the embodiments may be implemented as independently as possible. The operations explained with reference to the corresponding flowchart in each of the embodiments may be changed in their order if at all possible.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a first interface;
a wireless communication unit which is capable of wireless communication;
a first memory which is nonvolatile and capable of storing data; and
a second memory which is capable of temporarily holding data received by the wireless communication unit,
wherein the wireless communication unit sets, by transmitting a first frame, a period during which data is not transmitted to the wireless communication unit when remaining capacity of the second memory has become smaller than first capacity.

2. The device according to claim 1, wherein the wireless communication unit clears the period by transmitting a second frame when the remaining capacity of the second memory has become equal to or larger than the first capacity.

3. The device according to claim 1, wherein the first frame includes information indicating the length of the period.

4. The device according to claim 1, wherein the wireless communication unit is capable of storing information indicating the length of the period into the first frame,
if the information is included in the first frame, the period is cleared in response to an expiration of the period without the wireless communication unit transmitting a frame for clearing the period, and
if the information is not included in the first frame, the wireless communication unit clears the period by transmitting a second frame when the remaining capacity of the second memory has become equal to or larger than the first capacity.

5. The device according to claim 1, wherein the first frame includes first information indicating the remaining capacity of the second memory.

6. The device according to claim 5, wherein the first frame is capable of further storing second information that inhibits data transmission to the wireless communication unit,
if the first frame includes the second information and the second information inhibits the data transmission, the first information indicates the number of data frames the second memory is capable of receiving after the inhibition of the data transmission is cleared, and
if the second information does not inhibit the data transmission, the first information indicates the number of data frames the second memory is capable of receiving after the first frame is transmitted.

7. The device according to claim 1, wherein the first interface explicitly shows to the outside that the wireless communication unit is in wireless communication when the wireless communication unit starts to communicate.

8. The device according to claim 1, wherein the wireless communication unit transmits the first frame to inhibit data transmission to the wireless communication unit when the first interface accepts access if the wireless communication unit is in wireless communication.

9. The device according to claim 1, wherein the first interface is capable of wireless communication.

10. The device according to claim 1, wherein when the remaining capacity of the second memory has become smaller than the first capacity, the wireless communication unit compares a first period from when the first frame is transmitted until a data frame is received with a second period required for the remaining capacity of the second memory to increase to the first capacity or more and transmits the first frame on the basis of the comparison result.

11. A method of controlling a memory device including a first interface, a wireless communication unit, a first memory that is nonvolatile, and a second memory, the method comprising:
causing the wireless communication unit to receive first data by wireless communication;
storing the first data into the second memory; and
causing the wireless communication unit to inhibit data transmission to the memory device by transmitting a first frame by wireless communication when remaining capacity of the second memory has become smaller than first capacity.

12. The method according to claim 11, further comprising:
transferring the first data in the second memory to the first memory; and
clearing the inhibition of the data transfer by causing the wireless communication unit to transmit a second frame when the remaining capacity of the second memory has become equal to or larger than the first capacity.

13. The method according to claim 11, wherein the first frame includes information indicating the length of the inhibition period of the data transmission.

14. The method according to claim 11, wherein the wireless communication unit is capable of storing information indicating the length of the inhibition period of the data transfer into the first frame,
if the information is included in the first frame, the inhibition period is cleared in response to an expiration of the inhibition period without the wireless communication unit transmitting a frame for clearing the inhibition period, and
if the information is not included in the first frame, the wireless communication unit clears the inhibition period by transmitting a second frame when the remaining capacity of the second memory has become equal to or larger than the first capacity.

15. The method according to claim 11, wherein the first frame includes first information indicating the remaining capacity of the second memory.

16. The method according to claim 15, wherein the first frame is capable of further storing second information that inhibits data transmission to the wireless communication unit,
if the first frame includes the second information and the second information inhibits the data transmission, the first information indicates the number of data frames the second memory is capable of receiving after the inhibition of the data transmission is cleared, and
if the second information does not inhibit the data transmission, the first information indicates the number of data frames the second memory is capable of receiving after the first frame is transmitted.

17. The method according to claim 11, further comprising causing the first interface to explicitly show to the outside that the wireless communication unit is in wireless communication when the wireless communication unit starts to communicate.

18. The method according to claim 11, further comprising causing the wireless communication unit to transmit the first frame to inhibit data transmission to the wireless communication unit when the first interface accepts access if the wireless communication unit is in wireless communication.

19. The method according to claim 11, wherein the first interface is capable of wireless communication.

20. The method according to claim 11, wherein when the remaining capacity of the second memory has become smaller than the first capacity, the wireless communication unit compares a first period from when the first frame is transmitted until a data frame is received with a second period required for the remaining capacity of the second memory to increase to the first capacity or more and transmits the first frame on the basis of the comparison result.
